(19) United States
(12) Patent Application Publication
(10) Pub. No.: US 2026/0224993 A1
(43) Pub. Date: Aug. 6, 2026

(54) INDIRECT MODELING USING A VIRTUAL ENVIRONMENT

(71) Applicant: Wells Fargo Bank, N.A., San Francisco, CA (US)

(72) Inventors: Spencer McCoy Alexander, Charlotte, NC (US); Peter Ho, Walnut Creek, CA (US); Lucy Xi Zhang, Walnut Creek, CA (US)

(21) Appl. No.: 19/046,165

(22) Filed: Feb. 5, 2025

(51) Int. Cl. A63F 13/69; G06T 17/00

(52) U.S. Cl. CPC A63F 13/69; G06T 17/00

(57) ABSTRACT

System and techniques for indirectly modeling a phenomenon using a virtual environment are described herein. A set of behavioral conditions specific to an entity in a virtual environment can be obtained. These the conditions pertain to behaviors exclusive to the virtual environment. The behavior of the entity in the virtual environment is tracked in relation to these behavioral conditions to create a behavioral metric. Based on the behavioral metric, a predicted action value that corresponds to an activity not available in the virtual environment is generated for the entity. A representation of the predicted action value can then be transmitted for use in predicting entity behavior with respect to the activity not available in the virtual environment.

### TECHNICAL FIELD

Embodiments described herein generally relate to computer simulation and more specifically to indirect modeling using a virtual environment.

### BACKGROUND

A virtual environment is a simulated, digital space that mimics real-world or imagined settings, allowing users or systems to interact with it as if it were a physical environment. These environments are typically created using computer software and can range from simple, text-based simulations to highly complex, immersive 3D worlds. Virtual environments are often used in applications such as virtual reality (VR), gaming, training simulations, architectural visualization, and collaborative online spaces. The creation of a virtual environment involves the use of various technologies, including 3D modeling, physics engines, artificial intelligence, and networked communication protocols. These environments can be dynamic, responding to user inputs or external data in real-time, or static, providing a fixed space for exploration and interaction. The effectiveness of a virtual environment depends on factors such as graphical fidelity, interactivity, latency, or the degree of immersion provided to the user. Virtual environments can be useful tools for research, education, entertainment, or professional training.

Computer simulation is a computational technique used to study the characteristics (e.g., structure, behavior, etc.) of systems in a virtual environment. Computer simulation uses a model that represents the characteristics, relationships, or dynamics of the system being studied. These simulations enable experiments and observations under various conditions that can be difficult or impossible to achieve otherwise. The accuracy of a computer simulation depends on the fidelity of the model, which can be influenced by the quality of the input data, the assumptions made, or the computational methods employed. Simulations are widely used in fields such as physics, engineering, biology, economics, and social sciences to predict future behavior, optimize systems, or gain insights into complex phenomena.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for indirect modeling using a virtual environment, according to an embodiment.

FIG. 2 illustrates a communication flow between components, according to an embodiment.

FIG. 3 illustrates a flow diagram of an example of a method for indirect modeling using a virtual environment, according to an embodiment.

FIG. 4 is a block diagram illustrating an example of a machine upon which one or more embodiments may be implemented.

### DETAILED DESCRIPTION

Computer simulations have become important tools for understanding or predicting the behavior of complex systems across various domains, such as engineering, economics, or environmental science. However, the process of developing simulations that are specifically designed for a particular application can be both costly and time-consuming. This challenge is compounded by the need to accurately model the intricate details of the system, which often requires significant computational power and sophisticated algorithms. Furthermore, the integration of agents within the model that can effectively mimic real-world behaviors adds another layer of complexity. As the system's complexity grows, these challenges become more pronounced, making it increasingly difficult to create and maintain simulations that are both accurate and efficient.

Consider, for example, the development of a simulation to model urban traffic patterns. Creating a custom simulation for this purpose would involve constructing detailed models of road networks, traffic signals, vehicle behavior, and human driving patterns. Additionally, the simulation would need to account for various external factors, such as weather conditions or road construction, which could further complicate the model. The computational requirements for such a simulation are significant, as it would need to process a vast amount of data to provide accurate predictions. Moreover, developing agents that can realistically simulate human drivers' behavior under different conditions adds another layer of difficulty, making the entire process resource-intensive.

To address these issues, existing virtual environments can be leveraged using an indirect modeling technique. For instance, modern computer games often include highly detailed physical or social models that were originally designed for entertainment purposes. In some games, players manage a virtual city, making decisions about infrastructure, zoning, or public services. These games incorporate complex algorithms to simulate the flow of traffic, the growth of the population, or other aspects of urban existence. These aspects of the virtual environment can be used to simulate real-world urban traffic patterns without the need to build a new simulation from scratch. In other games, players interact in sometimes fantastical virtual worlds, engaging in activities (e.g., quests, tasks, battles, etc.) that employ strategic thinking, cooperation, or competition. The players' actions and interactions provide rich data on human responses to a variety of conditions or stimuli that can be used to predict (e.g., model) social dynamics in other contexts. For example, the way players form alliances, compete for resources, or respond to threats in the game could be analyzed to understand similar behaviors in real-world scenarios, such as political negotiations, debt repayment, or market competition.

Indirect modeling using a virtual environment can include establishing a link between the behaviors observable in the virtual environment and those in the system being modeled when there is no direct connection. For example, if the virtual environment has a quest to slay a dragon, there is no direct analog when modeling productivity building shelves. However, there can be underlying mechanisms of action that are common between the virtual environment activity and the modeled system activity. In this example, the ability to following instructions or advice, gather supplies, and use the knowledge and tools to accomplish the stated goal. Accordingly, it can be inferred that a person's success in slaying dragons versus others provides some predictive power that the person will perform better at a cabinet shop than others.

Once the boundaries of the virtual environment behaviors are obtained, they can be embodied in a set of behavioral conditions. These conditions provide a way to measure the behavior and produce a metric. For example, a behavioral condition can include the time between starting a quest and completing it in a virtual environment. Here, the time provides a non-binary measure of the person's motivation, for example. The measured agent need not be a person. For example, a vehicle navigation system, automated collision avoidance system, computer vision system, etc. can be used to control characters in a game to ascertain efficiency of routing, identification of obstacles, or generalized classification on elements not found in the environment in which these systems typically operate.

During agent action in the virtual environment, the behavioral conditions are monitored and used to generate behavioral metrics, which can serve as the medium for translating the virtual behaviors into actionable insights for the modeled system. These behavioral metrics can be used to predict actions in the modeled system, even when the behaviors upon which the behavioral metric is based is exclusive to the virtual environment and the action that is predicated is absent from the virtual environment. These predictions can then be acted upon directly (e.g., to update autonomous driving computer action boundaries for safer driving performance) or communicated to another system to be acted upon (e.g., providing a credit score to a credit reporting bureau.

Indirect modeling using a virtual environment leverages existing virtual environments to model systems without the need to build new simulations from the ground up. Not only are time and resources saved, by the technique enables the exploration of scenarios or behaviors that are difficult or impossible to simulate using traditional techniques. Additional details and examples are provided below.

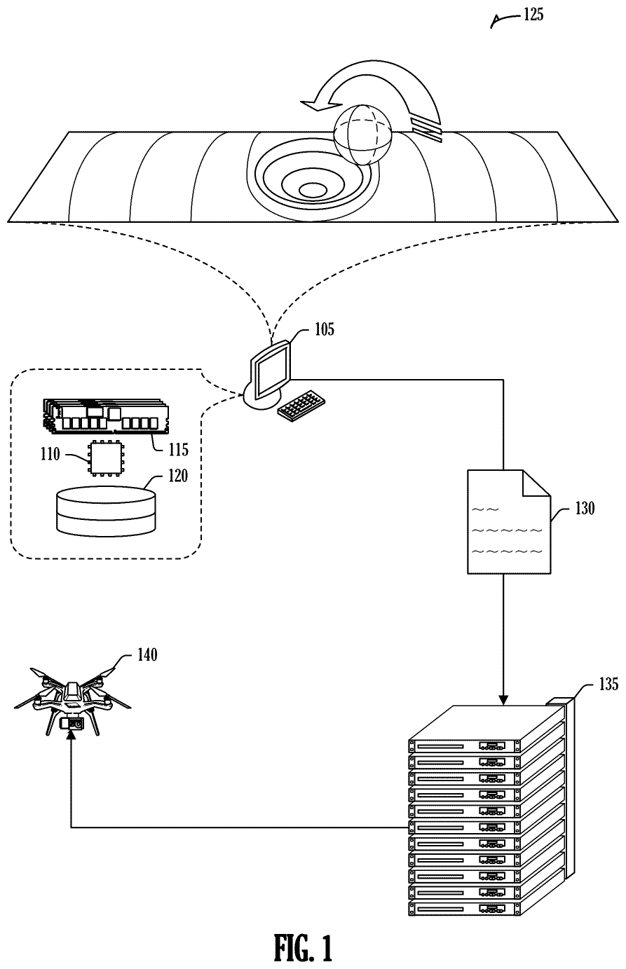

FIG. 1 is a block diagram of an example of an environment including a system 105 for indirect modeling using a virtual environment 125, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is generally discarded between system power cycles or restarts. The memory 115 and the storage 120 are both forms of computer readable media. The processing circuitry 110 or software residing in the memory 115 or storage 120 executing on the processing circuitry 110 configure the system 105 to perform various operations when in operation.

As illustrated, the system 105 is shown running the virtual environment 125. However, the virtual environment 125 can be run on different machines. The illustrated virtual environment 125 is a balance game in which a surface is titled to move the ball into various objectives, such as the illustrated depression. This type of balancing technique can be correlated to control systems for the drone 140. Thus, the illustrated virtual environment 125 is a balancing game and the modeled system is drone flight control. These examples are merely illustrative. Other examples, such as human social interaction, economic behavior, safety systems (e.g., in concert venues), etc. as the modeled system can benefit from a variety of rich and complicated games, such as massively multi-player online role-playing games.

The processing circuitry 110 is configured to obtain (e.g., retrieve, receive, create, etc.) a set of behavioral conditions for an entity represented in the virtual environment 125. The entity refers to an actor in the virtual environment that can control an aspect of the virtual environment 125. Accordingly, the entity can be a character controller by a human or computer, or the controls themselves, such as is the case in the illustrated ball balancing game.

In an example, a behavioral condition in the set of behavioral conditions pertains to a behavior exclusive to the virtual environment 125. This example highlights that the virtual environment 125 includes a behavior that is not represented elsewhere, at least not in the modeled system, providing the indirection of the modeling described herein. In an example, the entity is a human and the virtual environment 125 is a game. In an example, the behavioral condition is performance of a task in the game. In an example, the task is creation of an in-game object. These examples note a typical goal-oriented behavior in many games but that is exclusive to a given game. In an example, the task is completion of an in-game objective defined by the game that results in modification to a character attribute or character object. For example, completing a quest can result in a character leveling up. In an example, the in-game objective is a victory in a head-to-head competition in the game.

In an example, the task is completion of an in-game objective solely defined by the behavioral condition. For example, consider a game that has an economic system—such as a way to earn currency, spend currency, transfer currency, etc.—but was missing elements of the economic system such as loans. Then, the behavioral condition can be the repayment of a loan given to the player. Thus, the objective is not defined by the game, or the rules of the game, but only by the behavioral objective.

To extend the concept of a loan, in an example, obtaining the set of behavioral conditions includes the processing circuitry 110 allocating in-game resources (e.g., game currency, equipment, entry to a tournament, etc.) to the entity (e.g., a character of the human). In this case, the behavioral condition can be performance of a transfer of resources back from the entity (e.g., repaying the loan under terms of the original transfer). In an example, the resources back from the entity are from the character. This example captures the in-virtual environment nature of the transfer rather than, for example, a side-band payment made outside of the virtual environment 125. In an example, the processing circuitry 110 is configured to perform an involuntary—with respect to the entity—transfer of the resources based on a failure to meet the behavioral condition. In the example of loans, this example operates as a repossession of an in-game object or seizure of other assets. However, these same concepts can operate with respect to non-economic activities. For example, if the behavioral condition limits the degree to which the drone control software can tilt the surface of the ball game and grants additional “lives” to accomplish the task, the violation of the behavioral condition can result in the removal of the additional “lives” to end the training early, or to provide an additional feedback mechanism to improve training.

The processing circuitry 110 is configured to track (e.g., measure) entity behavior in the virtual environment 125 with respect to the behavioral condition. This measurement is used to create a behavioral metric. In an example, the behavioral metric is the raw (e.g., unchanged) measurement. In an example, the behavioral metric is derived (e.g., normalized, scaled, summed, etc.) from the behavioral condition observations taken from the virtual environment 125. The behavioral metric can be numeric (e.g., a floating point number), binary, or other forms.

In an example, tracking the entity behavior includes obtaining a log of actions in the virtual environment 125, and identifying the entity behavior from the log. This example enables the system 105 to time or space shift monitoring from, for example, another system running the virtual environment 125. In an example, the processing circuitry 110 is configured to operate as an agent in the virtual environment 125 and use input (e.g. scenes) available to the agent to perform the monitoring. These examples illustrate the variety of ways that the system 105 can gain the measurements of the entity acting within the virtual environment 125 with respect to the set of behavioral conditions.

The processing circuitry 110 is configured to create a predicted action value 130 for the entity based on the behavioral metric. This predicted behavior value 130 corresponds to an action that is absent from the virtual environment. For example, given the drone control system playing the illustrated ball game, the behavioral metric can include a frequency with which the ball rolls into and out of the depression. This suggests that the amplitude of the inputs (e.g., the tilting) are too great, resulting in the ball moving too quickly and bouncing out of the depression. This metric is turned into the predicted action value 130 that indicates the drone 140 under the control system will also use control inputs that are too great. In this case, the receiver 135 of the predicted action value 130 can train a more dampened control system for the drone 140 based on the predicted action value 130. Another interesting example, can include the predicted action metric 130 as a credit score where the behavioral metric is based on in-game compliance (e.g., completing quests, repayment of loaned artifacts, etc.).

The processing circuitry 110 is configured to transmit a representation of the predicted action value 130 to a receiver 135. This transmission enables the predicted action value 130 to be acted upon. For example, the predicted action value 130 can be used to adjust training or design of control systems. An example control system includes lending based on risk. Another example of a control system can include traffic light actuation to improve traffic flow or safety, air traffic control signaling, or computer network routing among others.

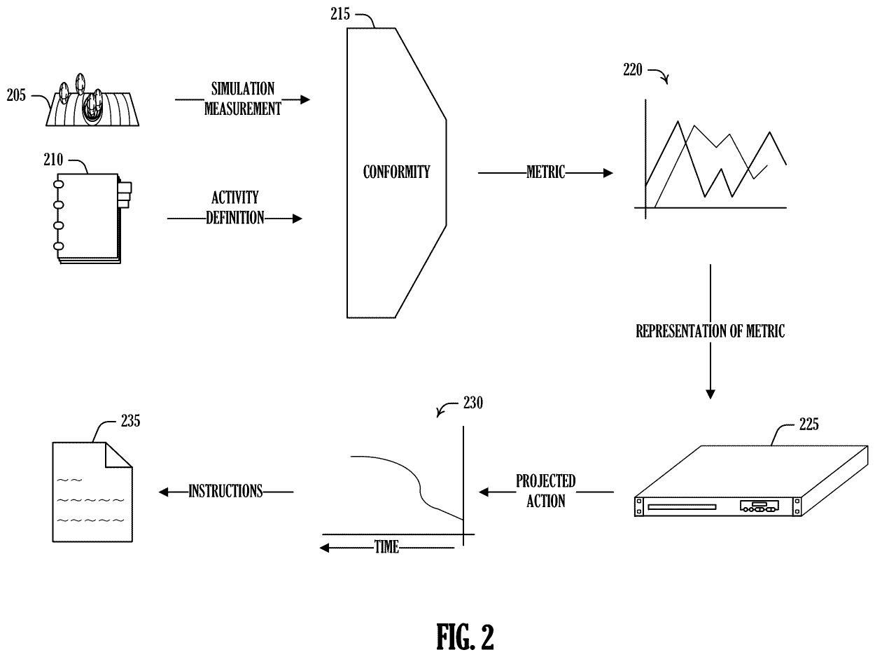

FIG. 2 illustrates a communication flow between components, according to an embodiment. As illustrated, data from the virtual environment 205 (e.g., a simulation) and a set of behavioral conditions 210 are provided as inputs to measurement circuitry 215 that measures conformity of the measurements to the set of behavioral conditions 210. The output of the measurement circuitry 215 is one or more behavioral metrics 220.

The behavioral metrics 220 can be sent raw (e.g., unchanged) or a representation of the behavioral metrics are processed by the system 225 to produce one or more projected action values 230. The projected action values 230 can then be transmitted to, for example, produce instructions 235 (e.g., control system changes), guidelines (e.g., a credit report), or other effects based on the predicted action of an entity. As noted earlier, the predicted action values 230 can pertain to an action that is not represented in the virtual environment 205 and the behaviors measured from the virtual environment are restricted (e.g., exclusive to) the virtual environment 205. Thus, the modeling of the target system represented by the predicted action values 235 is indirectly related to the behaviors monitored in the virtual environment 205.

An interesting use case for such indirect modeling using the virtual environment 205 can include modeling real-world fiscal behavior through unrelated gameplay. For example, an entity can provide credit in-game to a player to, for example, participate in a tournament, to purchase items or upgrades, or other actions that are purely in-game. This credit can involve use of in-game currency, in-game goods (e.g., magic items, skins, etc.), real estate, or other virtual assets that are lent to the player, for example, via an avatar or other in-game medium. Thus, a virtual credit or loan system is created where players can borrow in-game currency to invest in gaming projects, tournaments, or virtual real estate. These loans would come with repayment terms and interest rates that players manage.

Underwriting of loans for a player can be based on in-game actions, currency value, or other aspects that are absent from the real-world and thus not considered by real-world underwriting. For example, if the player is a grinder (e.g., regularly mines gold in a game), they can be approved for the loan, even if they wouldn't qualify for the loan based on their current financial condition or life (e.g., they are young with no credit history). That is, in at least one example, the in-game actions of the character may include a repeated (often times, excessively repeated) general task in order to gain in-game assets, such as in-game resources, currency, experience, etc. (i.e., grinding). In an example, the in-game actions of the character may include repeated success when solving difficult in-game problems or puzzles (e.g., a behavior of critical thinking and problem solving). In yet another example, the in-game actions may relate to a competitive rank of the character within the game. A competitive rank may refer to an in-game skill-based tier or numerical value that represents a character's performance compared to other players in a given game mode. Thus, a game skill-based or creator-based line of credit can be established. This can include an in-game income that is part of the risk profile for the player.

The ability to ascertain player behavioral responses from the game behavior can be used for non-game actions. This indirect modeling can, for example, be used in a credit report for loan risk assessment in traditional settings. Thus, an in-game loan that is responsibly handled by the player can be used as the basis for real-world credit.

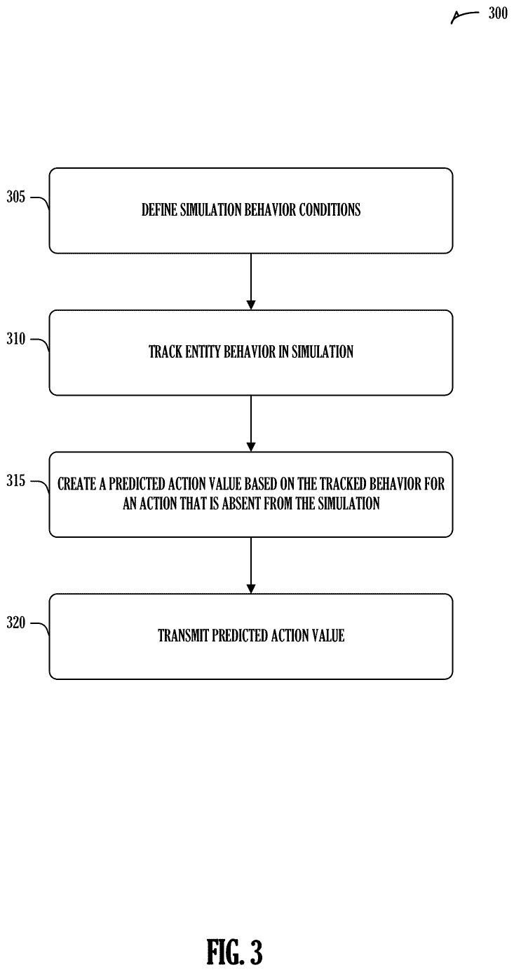

FIG. 3 illustrates a flow diagram of an example of a method 300 for indirect modeling using a virtual environment, according to an embodiment. The operations of the method 300 are performed by computational hardware, such as that described above or below (e.g., processing circuitry).

At operation 305, a set of behavioral conditions for an entity represented in a virtual environment is established. Establishing the set of behavioral conditions can include, for example, creating or loading a list of behaviors with parameters for success or failure. In an example, a behavioral condition in the set of behavioral conditions pertains to a behavior exclusive to the virtual environment. In an example, the entity is a human and the virtual environment is a game. In an example, the behavioral condition is performance of a task in the game. In an example, the task is creation of an in-game object.

In an example, the task is completion of an in-game objective defined by the game that results in modification to a character attribute or character object. In an example, the in-game objective is a victory in a head-to-head competition in the game. In an example, the task is completion of an in-game objective solely defined by the behavioral condition.

In an example, obtaining the set of behavioral conditions includes an allocation of in-game resources to a character of the human, and the behavioral condition is performance of a transfer of resources back from the human. In an example, the resources back from the human are from the character. In an example, the operations of the method 300 can include performing an involuntary transfer of the resources from the human based on a failure to meet the behavioral condition.

At operation 310, entity behavior in the virtual environment with respect to the behavioral condition is tracked to create a behavioral metric. In an example, tracking the entity behavior includes obtaining a log of actions in the virtual environment, and identifying the entity behavior from the log.

At operation 315, a predicted action value is created for the entity based on the behavioral metric. Creating the prediction action value can include, for example, using the predicated action value as a probability of success based on a ratio of success or failure represented by the behavioral metric. This predicted behavior value corresponds to an action that is absent from the virtual environment.

At operation 320, a representation of the predicted action value is transmitted. In an example, where the behavior that is exclusive to the virtual environment is repayment of a loan, the representation of the predicted action value is part of a credit report.

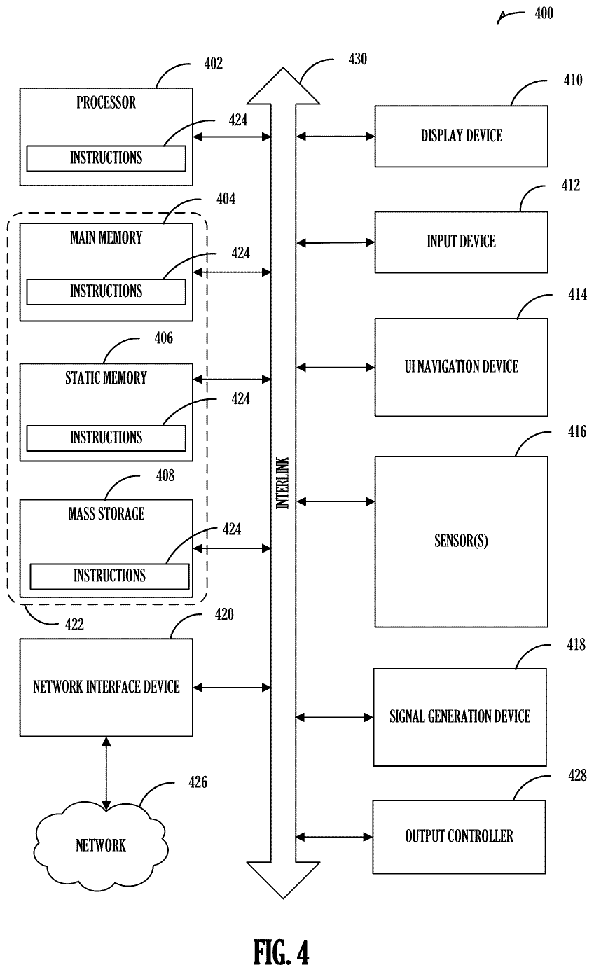

FIG. 4 illustrates a block diagram of an example machine 400 upon which any one or more of the techniques (e.g., methodologies) discussed herein may perform. Examples, as described herein, may include, or may operate by, logic or a number of components, or mechanisms in the machine 400. Circuitry (e.g., processing circuitry) is a collection of circuits implemented in tangible entities of the machine 400 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 400 follow.

In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 400 may include a hardware processor 402 (e.g., a central processing unit (CPU), a graphics processing unit (GPU), a hardware processor core, or any combination thereof), a main memory 404, a static memory (e.g., memory or storage for firmware, microcode, a basic-input-output (BIOS), unified extensible firmware interface (UEFI), etc.) 406, and mass storage 408 (e.g., hard drives, tape drives, flash storage, or other block devices) some or all of which may communicate with each other via an interlink (e.g., bus) 430. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 408, a signal generation device 418 (e.g., a speaker), a network interface device 420, and one or more sensors 416, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 402, the main memory 404, the static memory 406, or the mass storage 408 may be, or include, a machine readable medium 422 on which is stored one or more sets of data structures or instructions 424 (e.g., software) embodying or utilized by any one or more of the techniques or functions described herein. The instructions 424 may also reside, completely or at least partially, within any of registers of the processor 402, the main memory 404, the static memory 406, or the mass storage 408 during execution thereof by the machine 400. In an example, one or any combination of the hardware processor 402, the main memory 404, the static memory 406, or the mass storage 408 may constitute the machine readable media 422. While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 422 may be representative of the instructions 424, such as instructions 424 themselves or a format from which the instructions 424 may be derived. This format from which the instructions 424 may be derived may include source code, encoded instructions (e.g., in compressed or encrypted form), packaged instructions (e.g., split into multiple packages), or the like. The information representative of the instructions 424 in the machine readable medium 422 may be processed by processing circuitry into the instructions to implement any of the operations discussed herein. For example, deriving the instructions 424 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 424.

In an example, the derivation of the instructions 424 may include assembly, compilation, or interpretation of the information (e.g., by the processing circuitry) to create the instructions 424 from some intermediate or preprocessed format provided by the machine readable medium 422. The information, when provided in multiple parts, may be combined, unpacked, and modified to create the instructions 424. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 424 may be further transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software. A transmission medium is a machine readable medium.

### ADDITIONAL NOTES & EXAMPLES

Example 1 is an apparatus for indirect modeling using a virtual environment, the apparatus comprising: a memory including instructions; and processing circuitry that, when in operation, is configured by the instructions to: obtain a set of behavioral conditions for an entity represented in a virtual environment, the virtual environment being a computer virtual environment, a behavioral condition in the set of behavioral conditions pertaining to a behavior exclusive to the virtual environment; track entity behavior in the virtual environment with respect to the behavioral condition to create a behavioral metric; create a predicted action value for the entity based on the behavioral metric, the predicted action value corresponding to an action that is absent from the virtual environment; and transmit a representation of the predicted action value.

In Example 2, the subject matter of Example 1, wherein the entity is a human and the virtual environment is a game.

In Example 3, the subject matter of Example 2, wherein the behavioral condition is performance of a task in the game.

In Example 4, the subject matter of Example 3, wherein the task is creation of an in-game object.

In Example 5, the subject matter of any of Examples 3-4, wherein the task is completion of an in-game objective defined by the game that results in modification to a character attribute or character object.

In Example 6, the subject matter of Example 5, wherein the in-game objective is a victory in a head-to-head competition in the game.

In Example 7, the subject matter of any of Examples 3-6, wherein the task is completion of an in-game objective solely defined by the behavioral condition.

In Example 8, the subject matter of any of Examples 2-7, wherein, to obtain the set of behavioral conditions, the processing circuitry is configured by the instructions when in operation to perform an allocation of in-game resources to a character of the human, and wherein the behavioral condition is performance of a transfer of resources back from the human.

In Example 9, the subject matter of Example 8, wherein the resources back from the human are from the character.

In Example 10, the subject matter of any of Examples 8-9, wherein the processing circuitry is configured by the instructions when in operation to perform an involuntary transfer of the resources from the human based on a failure to meet the behavioral condition.

In Example 11, the subject matter of any of Examples 1-10, wherein the behavior is repayment of a loan.

In Example 12, the subject matter of Example 11, wherein the representation of the predicted action value is part of a credit report.

In Example 13, the subject matter of any of Examples 1-12, wherein, to track the entity behavior, the processing circuitry is configured by the instructions when in operation to: obtain a log of actions in the virtual environment; and identify the entity behavior from the log.

Example 14 is a method for indirect modeling using a virtual environment, the method comprising: obtaining a set of behavioral conditions for an entity represented in a virtual environment, the virtual environment being a computer virtual environment, a behavioral condition in the set of behavioral conditions pertaining to a behavior exclusive to the virtual environment; tracking entity behavior in the virtual environment with respect to the behavioral condition to create a behavioral metric; creating a predicted action value for the entity based on the behavioral metric, the predicted action value corresponding to an action that is absent from the virtual environment; and transmitting a representation of the predicted action value.

In Example 15, the subject matter of Example 14, wherein the entity is a human and the virtual environment is a game.

In Example 16, the subject matter of Example 15, wherein the behavioral condition is performance of a task in the game.

In Example 17, the subject matter of Example 16, wherein the task is creation of an in-game object.

In Example 18, the subject matter of any of Examples 16-17, wherein the task is completion of an in-game objective defined by the game that results in modification to a character attribute or character object.

In Example 19, the subject matter of Example 18, wherein the in-game objective is a victory in a head-to-head competition in the game.

In Example 20, the subject matter of any of Examples 16-19, wherein the task is completion of an in-game objective solely defined by the behavioral condition.

In Example 21, the subject matter of any of Examples 15-20, wherein obtaining the set of behavioral conditions includes an allocation of in-game resources to a character of the human, and wherein the behavioral condition is performance of a transfer of resources back from the human.

In Example 22, the subject matter of Example 21, wherein the resources back from the human are from the character.

In Example 23, the subject matter of any of Examples 21-22, comprising performing an involuntary transfer of the resources from the human based on a failure to meet the behavioral condition.

In Example 24, the subject matter of any of Examples 14-23, wherein the behavior is repayment of a loan.

In Example 25, the subject matter of Example 24, wherein the representation of the predicted action value is part of a credit report.

In Example 26, the subject matter of any of Examples 14-25, wherein tracking the entity behavior includes: obtaining a log of actions in the virtual environment; and identifying the entity behavior from the log.

Example 27 is a machine readable medium including instructions for indirect modeling using a virtual environment, the instructions, when executed by processing circuitry, cause the processing circuitry to perform operations comprising: obtaining a set of behavioral conditions for an entity represented in a virtual environment, the virtual environment being a computer virtual environment, a behavioral condition in the set of behavioral conditions pertaining to a behavior exclusive to the virtual environment; tracking entity behavior in the virtual environment with respect to the behavioral condition to create a behavioral metric; creating a predicted action value for the entity based on the behavioral metric, the predicted action value corresponding to an action that is absent from the virtual environment; and transmitting a representation of the predicted action value.

In Example 28, the subject matter of Example 27, wherein the entity is a human and the virtual environment is a game.

In Example 29, the subject matter of Example 28, wherein the behavioral condition is performance of a task in the game.

In Example 30, the subject matter of Example 29, wherein the task is creation of an in-game object.

In Example 31, the subject matter of any of Examples 29-30, wherein the task is completion of an in-game objective defined by the game that results in modification to a character attribute or character object.

In Example 32, the subject matter of Example 31, wherein the in-game objective is a victory in a head-to-head competition in the game.

In Example 33, the subject matter of any of Examples 29-32, wherein the task is completion of an in-game objective solely defined by the behavioral condition.

In Example 34, the subject matter of any of Examples 28-33, wherein obtaining the set of behavioral conditions includes an allocation of in-game resources to a character of the human, and wherein the behavioral condition is performance of a transfer of resources back from the human.

In Example 35, the subject matter of Example 34, wherein the resources back from the human are from the character.

In Example 36, the subject matter of any of Examples 34-35, wherein the operations comprise performing an involuntary transfer of the resources from the human based on a failure to meet the behavioral condition.

In Example 37, the subject matter of any of Examples 27-36, wherein the behavior is repayment of a loan.

In Example 38, the subject matter of Example 37, wherein the representation of the predicted action value is part of a credit report.

In Example 39, the subject matter of any of Examples 27-38, wherein tracking the entity behavior includes: obtaining a log of actions in the virtual environment; and identifying the entity behavior from the log.

Example 40 is a system for indirect modeling using a virtual environment, the system comprising: means for obtaining a set of behavioral conditions for an entity represented in a virtual environment, the virtual environment being a computer virtual environment, a behavioral condition in the set of behavioral conditions pertaining to a behavior exclusive to the virtual environment; means for tracking entity behavior in the virtual environment with respect to the behavioral condition to create a behavioral metric; means for creating a predicted action value for the entity based on the behavioral metric, the predicted action value corresponding to an action that is absent from the virtual environment; and means for transmitting a representation of the predicted action value.

In Example 41, the subject matter of Example 40, wherein the entity is a human and the virtual environment is a game.

In Example 42, the subject matter of Example 41, wherein the behavioral condition is performance of a task in the game.

In Example 43, the subject matter of Example 42, wherein the task is creation of an in-game object.

In Example 44, the subject matter of any of Examples 42-43, wherein the task is completion of an in-game objective defined by the game that results in modification to a character attribute or character object.

In Example 45, the subject matter of Example 44, wherein the in-game objective is a victory in a head-to-head competition in the game.

In Example 46, the subject matter of any of Examples 42-45, wherein the task is completion of an in-game objective solely defined by the behavioral condition.

In Example 47, the subject matter of any of Examples 41-46, wherein the means for obtaining the set of behavioral conditions include means for an allocation of in-game resources to a character of the human, and wherein the behavioral condition is performance of a transfer of resources back from the human.

In Example 48, the subject matter of Example 47, wherein the resources back from the human are from the character.

In Example 49, the subject matter of any of Examples 47-48, comprising means for performing an involuntary transfer of the resources from the human based on a failure to meet the behavioral condition.

In Example 50, the subject matter of any of Examples 40-49, wherein the behavior is repayment of a loan.

In Example 51, the subject matter of Example 50, wherein the representation of the predicted action value is part of a credit report.

In Example 52, the subject matter of any of Examples 40-51, wherein the means for tracking the entity behavior include: means for obtaining a log of actions in the virtual environment; and means for identifying the entity behavior from the log.

Example 53 is at least one machine-readable medium including instructions that, when executed by processing circuitry, cause the processing circuitry to perform operations to implement of any of Examples 1-52.

Example 54 is an apparatus comprising means to implement of any of Examples 1-52.

Example 55 is a system to implement of any of Examples 1-52.

Example 56 is a method to implement of any of Examples 1-52.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine readable medium including instructions for indirect modeling using a virtual environment, the instructions, when executed by processing circuitry, cause the processing circuitry to perform operations comprising:
obtaining a set of behavioral conditions for an entity represented in a virtual environment, the virtual environment being a computer virtual environment, a behavioral condition in the set of behavioral conditions pertaining to a behavior exclusive to the virtual environment;
tracking entity behavior in the virtual environment with respect to the behavioral condition to create a behavioral metric;
creating a predicted action value for the entity based on the behavioral metric, the predicted action value corresponding to an action that is absent from the virtual environment; and
transmitting a representation of the predicted action value.

2. The non-transitory machine readable medium of claim 1, wherein the entity is a human and the virtual environment is a video game.

3. The non-transitory machine readable medium of claim 2, wherein the behavioral condition is performance of a task in the video game.

4. The non-transitory machine readable medium of claim 3, wherein the task is creation of an in-game object.

5. The non-transitory machine readable medium of claim 3, wherein the task is completion of an in-game objective defined by the video game that results in modification to a character attribute or character object.

6. The non-transitory machine readable medium of claim 5, wherein the in-game objective is a victory in a head-to-head competition in the video game.

7. The non-transitory machine readable medium of claim 3, wherein the task is completion of an in-game objective solely defined by the behavioral condition.

8. The non-transitory machine readable medium of claim 2, wherein obtaining the set of behavioral conditions includes an allocation of in-game resources to a character of the human, and wherein the behavioral condition is performance of a transfer of resources back from the human.

9. The non-transitory machine readable medium of claim 8, wherein the resources back from the human are from the character.

10. The non-transitory machine readable medium of claim 8, wherein the operations comprise performing an involuntary transfer of the resources from the human based on a failure to meet the behavioral condition.

11. A method for indirect modeling using a virtual environment, the method comprising:
obtaining a set of behavioral conditions for an entity represented in a virtual environment, the virtual environment being a computer virtual environment, a behavioral condition in the set of behavioral conditions pertaining to a behavior exclusive to the virtual environment;
tracking entity behavior in the virtual environment with respect to the behavioral condition to create a behavioral metric;
creating a predicted action value for the entity based on the behavioral metric, the predicted action value corresponding to an action that is absent from the virtual environment; and
transmitting a representation of the predicted action value.

12. The method of claim 11, wherein the entity is a human and the virtual environment is a video game.

13. The method of claim 12, wherein the behavioral condition is performance of a task in the video game.

14. The method of claim 13, wherein the task is creation of an in-game object.

15. The method of claim 13, wherein the task is completion of an in-game objective defined by the video game that results in modification to a character attribute or character object.

16. The method of claim 15, wherein the in-game objective is a victory in a head-to-head competition in the video game.

17. The method of claim 13, wherein the task is completion of an in-game objective solely defined by the behavioral condition.

18. The method of claim 12, wherein obtaining the set of behavioral conditions includes an allocation of in-game resources to a character of the human, and wherein the behavioral condition is performance of a transfer of resources back from the human.

19. The method of claim 18, wherein the resources back from the human are from the character.

20. The method of claim 18, comprising performing an involuntary transfer of the resources from the human based on a failure to meet the behavioral condition.
